(19) United States
(12) Patent Application Publication
(10) Pub. No.: US 2017/0305115 A1
(43) Pub. Date: Oct. 26, 2017

(54) COMPOSITE COMPONENT AND METHOD FOR THE PRODUCTION AND USE THEREOF

(71) Applicants: ThyssenKrupp Steel Europe AG, Duisburg (DE); ThyssenKrupp AG, Essen (DE)

(72) Inventor: Hans-Joachim SIEG, Braunschweig (DE)

(73) Assignees: ThyssenKrupp Steel Europe AG, Duisburg (DE); ThyssenKrupp AG, Essen (DE)

(21) Appl. No.: 15/533,674

(22) PCT Filed: Oct. 30, 2015
(86) PCT No.: PCT/EP2015/075319

§ 371 Date: Jun. 7, 2017

(30) Foreign Application Priority Data
Dec. 11, 2014 (DE) 10 2014 225 576.7

(51) Int. Cl. B32B 15/08; B32B 15/18; B32B 15/20

(52) U.S. Cl. CPC B32B 15/08; B32B 15/20; B32B 15/18; B32B 2250/03

(57) ABSTRACT

A composite component may comprise at least one first steel workpiece, at least one second metal workpiece, and at least one polymer disposed between the first and second workpieces. Further, a process for the production of the composite component is disclosed. One object of the present disclosure concerns a composite component that has a lower mass compared to conventional use-specific components. The at least one polymer may be in the form of a polymer layer, which may be adhesively bonded to the first steel workpiece and to the second metal workpiece over substantially a full area of the polymer layer.

The invention relates to a composite component comprising at least one first steel workpiece, at least one second metal workpiece with at least one polymer arranged in between. The invention further relates to a corresponding process for the production thereof and to the use thereof.

Metal/polymer/metal composites, in particular, are known in the prior art. The applicant markets, under the trade name Litecor®, sandwich sheets which consist of two steel sheet covering layers composed of a cold, deep-drawable steel material having a material thickness in the range from 0.2 to 0.3 mm and a polymer core layer which is arranged between the steel sheet covering layers and has a material thickness of at least 0.3 mm, which sandwich sheets are cold formed as composite to give components and are outstandingly suitable as exterior and/or interior parts, in particular for passenger motor vehicles.

The patent document 10 2006 058 601 B4 which discloses a process for producing highly stressed hybrid components which are composed of at least one hot formed metal material and a fiber-reinforced polymer which is locally adhesively bonded thereto is known from the prior art. A sandwich-like configuration produced by provision of an additional second metal material which is bonded on to the fiber-reinforced polymer is also mentioned by way of example in this document. The hybrid components produced are suitable for highly stressed chassis and bodywork components which are partially reinforced by means of the fiber-reinforced polymer.

Furthermore, components which, for example, make a certain contribution to crash management are known in vehicles, for example floor plates in the vehicle. Here, microalloyed steels having material thicknesses of about 0.8 mm, which can assume functions in the event of a side crash load, are used. Increasing the strength could enable the material thickness to be reduced by maintaining the same mechanical properties, so that there is the potential of a material thickness reduction by, for example, the use of conventionally upgradeable steels, but this can, for example, have a negative effect on a required minimum stiffness. The lightweight construction potential is not yet fully exhausted, in particular in vehicle construction and also in commercial vehicle construction.

It was an object of the invention to provide a composite component which, compared to conventional use-specific components, has a lower mass, and also to propose a process for producing composite components by means of which lightweight components can be produced economically and to indicate the use of these.

The object for the composite component is achieved by the polymer being configured as polymer layer and being adhesively bonded over substantially its full area to the first steel workpiece and to the second metal workpiece, with the steel workpiece being partially or fully hardened.

The inventor has found that the combination of at least one heat-treated steel workpiece, i.e. a partially or completely hardened, in particular press-hardened steel workpiece, a polymer bonded on over substantially the full area and a further second metal workpiece bonded substantially over the full area to the polymer enables the material thickness of the steel workpiece and/or of the second material workpiece to be reduced further depending on the intended use, in particular by means of the at least partial or full high strength in the steel workpiece, without having an adverse effect on the characteristics of the composite component, i.e. the component has similar, preferably better properties, in particular a better stiffness, compared to conventional use-specific components, as a result of which a reduction in the mass is possible. The material thickness of the heat-treated steel workpiece is not more than 1.5 mm, in particular not more than 1.0 mm, preferably not more than 0.5 mm and particularly preferably not more than 0.35 mm. The material thickness of the polymer is at least 0.2 mm, in particular at least 0.3 mm, preferably at least 0.4 mm. As heat-treatable steel materials, manganese-boron steels are mainly used. The use of other steel grades which have a relatively high strength as a result of a heat treatment and compared to the as-delivered state is also conceivable. As polymer, preference is given to using thermoplastics which are heat resistant up to at least 200° C., in particular up to at least 220° C. Preferred polymers are, for example, systems based on PA, PE and/or mixtures thereof. For the purposes of the present invention, a substantially full-area adhesive bond means that the polymer is configured as a full area of polymer or else local regions, particularly in the peripheral region of the composite component, can be freed of polymer, in which regions joining to further components, in particular by means of adhesive and/or welded joins, preferably by means of resistant point welding joins, can be carried out without problems.

In a first embodiment of the composite component of the invention, the at least second metal workpiece is an aluminum workpiece, a magnesium workpiece or a steel workpiece, in particular an heat-treated steel workpiece. The second steel workpiece is particularly preferably heat-treated, i.e. it is a partially or completely hardened, in particular press-hardened, steel workpiece, with the material thickness of the heat-treated second steel workpiece being not more than 1.5 mm, in particular not more than 1.0 mm, preferably not more than 0.5 mm and particularly preferably not more than 0.35 mm. The material thicknesses of the first and second steel workpiece can be made identical or different, depending on the intended use. Depending on the intended use, aluminum workpieces or magnesium workpieces having material thicknesses of not more than 2.0 mm, in particular not more than 1.5 mm, preferably not more than 1.0 mm and particularly preferably not more than 0.5 mm, which owing to their lower density can bring about a further reduction in the mass compared to steel, can also be used as second metal workpieces. The material thickness of the first and/or second metal workpiece is at least 0.15 mm, in particular at least 0.2 mm, preferably at least 0.25 mm, in order to ensure a certain strength.

According to a further aspect, the invention provides a process for producing a composite component, which comprises the following process steps:

provision of at least one first semifinished metal part composed of a steel material and at least one second semifinished metal part, hot forming of the steel material to give a steel workpiece and forming of the at least second semifinished metal part to give a metal workpiece, provision of the steel workpiece, at least one semifinished polymer part and the metal workpiece for composite component production, placing of the at least first hot steel workpiece, the at least first semifinished polymer part and the at least second metal workpiece in a composite production tool to produce an adhesive bond between the individual workpieces. According to the invention, the first steel material is firstly partially or completely heated to a temperature above Act, in particular to a temperature above A_{c3}, of the steel material. The first steel material can be provided as a flat plate which has been cut to size or as cold, preformed semifinished steel part which, in particular, has virtually the final geometry to be produced. In technical circles, the first case is referred to as direct hot forming and the second case is referred to as indirect hot forming. The heated steel workpiece is transferred to and placed in a forming/hardening tool and hot formed and/or (partially or completely) hardened, in particular press-hardened, in the forming/hardening tool to give a steel workpiece. If different microstructures in the steel workpiece are to be taken into account in component-specific crash performance design, this is referred to as “tailored tempering”, i.e. a hard microstructure and a softer microstructure, in particular a microstructure which is more ductile than the hard microstructure, are produced. Furthermore, the geometry of the metal workpieces are matched to one another and the dimensions of the semifinished polymer part are adapted to the geometry of the metal workpieces in such a way that a substantially full-area adhesive bond between the semifinished polymer part and the steel workpiece and between the semifinished polymer part and the second metal workpiece can be produced under the action of heat and/or pressure in the composite production tool.

In order to avoid repetition, reference is made to what has been said above. The joining regions of the composite component to other components can be determined component-specifically and accordingly taken into account in the semifinished polymer part by provision of local cut-outs (perforation). The polymer layer can be placed hot into the composite production tool, in particular can already have been preformed, with it being adapted to the geometry of the metal workpieces in order to be able to produce a substantially full-area adhesive bond.

In a first embodiment of the process of the invention, the second semifinished metal part is made of an aluminum material, a magnesium material or a steel material, in particular an heat-treatable steel material, which is, in particular, hot formed to give a second metal workpiece which is preferably placed in the hot state in the composite production tool.

In a further preferred embodiment of the process of the invention, a second steel material is partially or completely heated at a temperature above Act, in particular at a temperature above A_{c3}, of the second steel material, transferred to and placed in a forming/hardening tool and hot formed and/or (partially or completely) hardened, in particular press-hardened, in the forming/hardening tool to give a steel workpiece. In particular, the partially or completely hardened first and/or second steel workpiece can be taken out from the forming/hardening tool at a temperature above 220° C., in particular above 240° C., preferably above 260° C., and transferred to and placed in the composite production tool in the hot state. Here, composite production can advantageously be carried out continuously “in-line” by means of a plurality of successive process steps.

In a further embodiment of the process of the invention, previously preformed and, for example, recooled first and/or second metal workpieces which have been temporarily stored can be heated to a temperature above 220° C., in particular above 240° C., preferably above 260° C., before being placed in the composite production tool. This can, for example, be carried out in conventional ovens, in particular tunnel kilns, or, as an alternative or in addition, by means of heating devices integrated into handling apparatuses (transfer unit), which can, for example, heat the first and/or second metal workpieces or maintain them at temperature inductively, conductively or radiatively before they are placed in a composite production tool.

In a further embodiment of the process of the invention, the first and/or the second metal workpiece and/or the semifinished polymer part can be partially coated or coated over their full area with a bonding coating in each case on the joining surface before placing in the composite production tool. The bonding layer can contribute to increasing the adhesion between the polymer and the metal workpieces and can be sprayed on, for example by means of robots provided with spraying devices. Other application methods are likewise conceivable.

According to a further aspect, the invention provides for use of the composite component of the invention as vehicle or chassis structure of a motor vehicle or commercial vehicle, in particular a crash-bearing motor vehicle/commercial vehicle structure such as floor plate, longitudinal beam, crash box, transverse beam, sill, A-, B-, C-, D-column, suspension arm or torque rod. In order to avoid repetition, reference is also made at this juncture to what has been said above.

In the following, the invention is illustrated with the aid of a drawing depicting working examples. Identical parts are denoted by the same reference numerals. The drawing shows

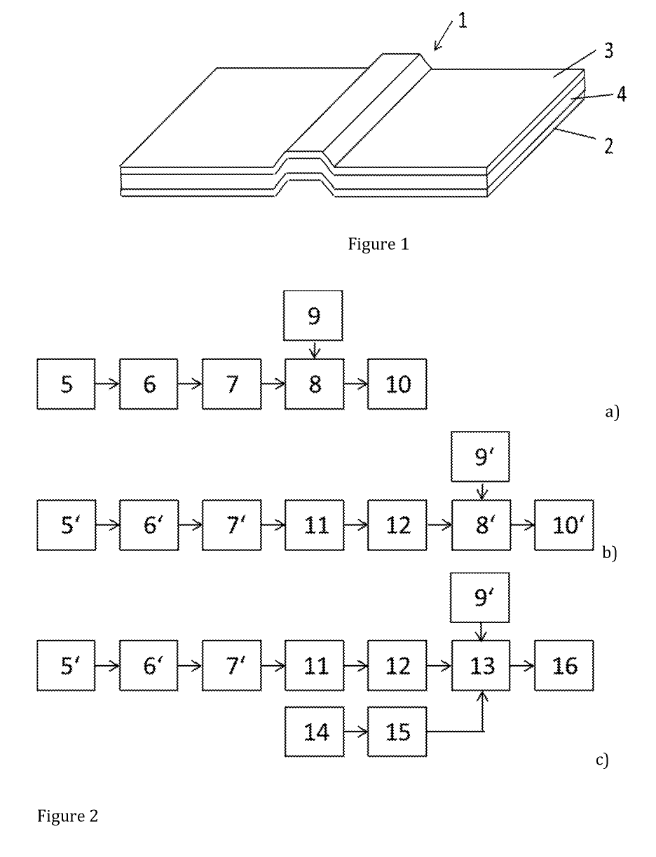

FIG. 1 a first working example of a composite component according to the invention in a perspective view and

FIG. 2a a first working example of a process according to the invention for producing a semifinished composite part,

FIG. 2b a second working example of a process according to the invention for producing a semifinished composite part and

FIG. 2c a third working example of a process according to the invention for producing a semifinished composite part.

FIG. 1 shows a first working example of a composite component 1 according to the invention in the form of a floor plate for a motor vehicle in a perspective view. The floor plate 1 comprises a first metal workpiece 2 which consists of a heat-treated steel workpiece and is partially or completely hardened, preferably press-hardened. The material thickness of the heat-treated steel workpiece 2 is, for example, 0.25 mm. The floor plate 1 further comprises a second metal workpiece 3 which can likewise consist of a heat-treated steel workpiece and is partially or completely hardened, preferably press-hardened. Between the first steel workpiece 2 and the second steel workpiece 3, there is a polymer 4 which is adhesively bonded as polymer layer over substantially the full area to the first steel workpiece 2 and to the second metal workpiece 3. The substantially full-area adhesive bond can be formed by a polymer layer which is uninterrupted over the full area or by a polymer layer having local polymer-free regions in which joining to further components, in particular by means of adhesive and/or welded joins, preferably by means of resistance point welding joins, can be carried out without problems.

FIG. 2a depicts a first working example of a process according to the invention for producing a composite component in a schematic sequence. Blanks are cut to size from a continuous strip or previously precut plates are provided on a stack (step 5). The blanks are made of a heat-treated steel material, in particular a manganese-boron steel material. This is preferably provided on both sides with a metallic coating, in particular a coating based on Al or Zn. A zinc-based coating is preferably applied electrolytically. The material thickness of the heat-treated steel material is not more than 1.5 mm, in particular not more than 1.0 mm, preferably not more than 0.5 mm and particularly preferably not more than 0.35 mm. The heat-treated steel material is provided for producing the first and second steel workpiece. For this purpose, the blanks are firstly completely heated or heated through, for example in an oven, in particular in a tunnel kiln, to a temperature above Act, preferably to a temperature above A_{c3}, of the steel material (step 6). After heating, the steel material, which preferably has a fully austenitic microstructure, is transferred to and placed in a forming/hardening tool by means of suitable devices (transfer unit) which are not shown and hot formed and (partially or completely) hardened, in particular press-hardened, in the forming/hardening tool (step 7). Complete hardening occurs in a cold, in particular an actively cooled, tool which cools the steel workpiece to be hardened in such a way that complete conversion from the austenitic microstructure into a bainitic and/or martensitic and thus a hard microstructure occurs. In partial hardening, on the other hand, at least one region in the tool is actively heated so that in this region a transformation within the steel workpiece into a hard microstructure cannot occur. After the steel workpiece has been partially or completely hardened, it is taken out from the forming/hardening tool at a temperature above 220° C., in particular above 240° C., preferably above 260° C., by means of suitable devices (transfer unit) which are not shown and transferred to and placed in an open composite production tool in the hot state coming from step 7. Here, composite production can advantageously be carried out “in-line” by means of a plurality of successive process steps. Firstly, a first partially or completely hardened steel workpiece is provided and placed in the composite production tool.

A polymer, in particular in the form of a polymer layer, is placed, preferably hot, by means of suitable devices (transfer unit) which are not shown in the open composite production tool into which the first steel workpiece has already been placed (step 9), with the polymer layer being able to be, in particular, already preformed and being adapted substantially to the geometry of the metal workpieces in order to be able to produce an essentially full-area adhesive bond to the metal workpieces. As second metal workpiece, use is made of a second heat-treated steel workpiece which likewise goes through the sequence of steps 5-7, with the steel workpiece having been partially or completely hardened, which second metal workpiece was taken out from the forming/hardening tool at a temperature above 220° C., in particular above 240° C., preferably above 260° C., by means of suitable devices (transfer unit) which are not shown and in the hot state coming from step 7 is transferred to and placed in the open composite production tool into which the first steel workpiece and the polymer layer have already been placed. The composite production tool comprises, for example, a lower tool (die) and an upper tool (punch). Relative movement of the two halves of the tool results, under the action of heat and pressure in the closed state (UT) of the composite production tool, in a substantially full-area adhesive bond between the polymer and the first steel workpiece and between the polymer and the second steel workpiece (step 8), with the geometry of the first and second steel workpiece being matched to one another and the dimensions of the polymer being adapted to the geometry of the steel workpieces. Heating/cooling devices which can maintain the tool at a preset temperature can be additionally integrated into the composite production tool so as to be able to even out possible temperature fluctuations within the first and/or second steel workpiece after placing in the tool and/or setting the temperature (depending on the polymer), in particular, so that a substantially full-area adhesive bond can be ensured. After opening the composite production tool, the finished composite component is taken out (step 10).

FIG. 2b depicts a second working example of a process according to the invention for producing a composite component in a schematic sequence. To avoid repetition, reference is made to the description for FIG. 2a, with the steps 5′-7′ corresponding to the steps 5-7. After the steel workpieces had been partially or completely hardened, the previously shaped and temporarily recooled heat-treated steel workpieces were subjected to intermediate storage (step 11). For composite production, the first and second heat-treated steel workpieces which have been subjected to intermediate storage are heated to a temperature above 220° C., in particular above 240° C., preferably above 260° C. (step 12), before being placed in a composite production tool. This can, for example, occur in conventional ovens, in particular tunnel kilns, but, as an alternative or in addition, by means of heating devices integrated into handling apparatuses (transfer unit) which can, for example, heat the first and second workpiece or maintain them at temperature inductively, conductively or radiatively before they are placed in the composite production tool. The description for steps 8′-10′ is carried over from the description for steps 8-10 in FIG. 2a.

FIG. 2c depicts a third working example of a process according to the invention for producing a composite component in a schematic sequence. To avoid repetition, reference is made to the description for steps 5′-7′ and 11-12 for FIG. 2b, merely with the difference that only a first heat-treated steel workpiece is provided for composite production. For composite production, aluminum or magnesium are, depending on the intended use, provided as second metal materials having material thicknesses of not more than 2.0 mm, in particular not more than 1.5 mm, preferably not more than 1.0 mm and particularly preferably not more than 0.5 mm (step 14), as a result of which a further reduction in the mass can be brought about due to the lower density compared to steel in the composite component. The second aluminum or magnesium workpiece which has been subjected to intermediate storage is heated to a temperature above 220° C., in particular above 240° C., preferably above 260° C. (step 15), before being placed in a composite production tool. This can, for example, occur in conventional ovens, in particular tunnel kilns, but, as an alternative or in addition, by means of heating devices integrated into handling apparatuses (transfer unit) which can, for example, heat the second aluminum or magnesium workpiece or maintain it at temperature inductively, conductively or radiatively before it is placed in the composite production tool. Firstly, either the first hot steel workpiece coming from step 12 or the hot aluminum or magnesium workpiece coming from step 15 is placed in the composite production tool. Regardless of the order, a polymer, in particular in the form of a polymer layer, is placed in between, preferably hot, by means of suitable devices (transfer unit) which are not shown in the open composite production tool in which the first steel workpiece or the second aluminum or magnesium workpiece has previously been placed (step 9′), where the polymer layer can, in particular, already have been preformed and is substantially adapted to the geometry of the metal workpieces in order to be able to produce a substantially full-area adhesive bond. The composite production tool comprises, for example, a lower tool (die) and an upper tool (punch). Relative movement of the two halves of the tool results, under the action of heat and pressure in the closed state (UT) of the composite production tool, in a substantially full-area adhesive bond between the polymer and the first steel workpiece and between the polymer and the second aluminum or magnesium workpiece (step 13), with the geometry of the first and second metal workpiece being matched to one another and the dimensions of the polymer being adapted to the geometry of the metal workpieces. Heating/cooling devices which can maintain the tool at a preset temperature can be additionally integrated into the composite production tool so as to be able to even out possible temperature fluctuations within the first steel workpiece or the second aluminum or magnesium workpiece after placing in the tool and/or setting the temperature (depending on the polymer), in particular, so that a substantially full-area adhesive bond can be ensured. After opening the composite production tool, the finished composite component is taken out with various metal workpieces (step 16).

The invention is not restricted to the working examples described in connection with the drawing.

### LIST OF REFERENCE NUMERALS

1 composite component

2 first steel workpiece

3 second metal workpiece

4 polymer, polymer layer

5-16 steps, process steps, process sequence

1.-11. (canceled)

12. A composite component comprising:
a first steel workpiece that is at least partially hardened;
a second metal workpiece; and
a polymer layer disposed between the first steel workpiece and the second steel workpiece, wherein the polymer layer is adhesively bonded to the first steel workpiece and to the second metal workpiece over substantially a full area of the polymer layer.

13. The composite component of claim 12 wherein the second metal workpiece is aluminum, magnesium, or steel.

14. The composite component of claim 13 wherein the second metal workpiece is at least partially hardened.

15. The composite component of claim 12 wherein a material thickness of the first steel workpiece is 1.5 mm or less.

16. The composite component of claim 12 wherein a material thickness of the first steel workpiece is 0.35 mm or less.

17. A process for producing a composite component, the process comprising:
providing a first semifinished metal part and a second semifinished metal part, the first semifinished metal part comprising a steel material;
hot forming the steel material to produce a steel workpiece by at least partially heating the steel material to a temperature above Ac1 of the steel material, placing the steel material in a forming/hardening tool, and hot forming and/or hardening the steel material in the forming/hardening tool;
forming the second semifinished metal part to produce a metal workpiece; and
placing the steel workpiece, a semifinished polymer part, and the metal workpiece in a composite production tool to adhesively bond the steel workpiece to the metal workpiece, wherein geometries of the steel workpiece and the metal workpiece are matched and dimensions of the semifinished polymer part are adapted to the geometries of the steel workpiece and the metal workpiece such that an adhesive bond, which is created between the semifinished polymer part and the steel workpiece and between the semifinished polymer part and the metal workpiece under at least one of heat or pressure in the composite production tool, occurs over substantially a full area of the semifinished polymer part.

18. The process of claim 17 wherein the second semifinished metal part is comprised of at least one of an aluminum material, a magnesium material, or a steel material.

19. The process of claim 17 wherein the second semifinished metal part is comprised of a heat-treated steel material.

20. The process of claim 17 wherein the second semifinished metal part is comprised of a heat-treated steel material that is hot formed to produce a second metal workpiece.

21. The process of claim 20 further comprising:
at least partially heating a second steel material to a temperature above Ac1 of the second steel material;
placing the second steel material in the forming/hardening tool; and
hot forming and/or hardening the second steel material in the forming/hardening tool to produce a second steel workpiece.

22. The process of claim 17 wherein the steel workpiece is removed from the forming/hardening tool at a temperature above 220° C. and the heated steel workpiece is placed in the composite production tool.

23. The process of claim 17 wherein the steel workpiece is heated to a temperature above 220° C. before being placed in the composite production tool.

24. The process of claim 17 wherein the steel workpiece is heated to a temperature above 240° C. before being placed in the composite production tool.

25. The process of claim 17 wherein the steel workpiece is heated to a temperature above 260° C. before being placed in the composite production tool.

26. The process of claim 17 further comprising at least partially coating at least one of the metal workpiece or the semifinished polymer part with a bonding coat on a joining surface before placing the at least one of the metal workpiece or the semifinished polymer part in the composite production tool.

27. The process of claim 17 further comprising installing the composite component in a vehicle.

28. The process of claim 17 further comprising installing the composite component as a floor plate, a longitudinal beam, a crash box, a transverse beam, a sill, an A-column, a B-column, a C-column, a D-column, a suspension arm, or a torque rod in a vehicle.
